(19) United States
(12) Patent Application Publication
(10) Pub. No.: US 2026/0261514 A1
(43) Pub. Date: Sep. 3, 2026

(54) TRAFFIC REAPPLYING JUDGMENT DEVICE, TRAFFIC REAPPLYING JUDGMENT METHOD, AND PROGRAM

(71) Applicant: Nippon Telegraph and Telephone Corporation, Tokyo (JP)

(72) Inventors: Mizuto NAKAMURA, Musashino-shi, Tokyo (JP); Yusuke MAKINO, Musashino-shi, Tokyo (JP); Atsushi TAKADA, Musashino-shi, Tokyo (JP); Kyoko YAMAGOE, Musashino-shi, Tokyo (JP)

(21) Appl. No.: 18/881,753

(22) PCT Filed: Jul. 12, 2022
(86) PCT No.: PCT/JP2022/027423

§ 371 Date: Jan. 7, 2025

(51) Int. Cl. H04L 47/125

(52) U.S. Cl. CPC H04L 47/125

(57) ABSTRACT

A traffic re-application determination device includes: a traffic summation unit that calculates a total sum of at least two traffics among a total sum of applied traffic applied to each IF of a predetermined standby NW device among a plurality of standby NW devices, a total sum of transmitted traffic transmitted from each IF of the predetermined standby NW device, and a total sum of received traffic received at each IF of a standby NW device other than the predetermined standby NW device; and a re-application determination unit that determines whether or not re-application of the applied traffic is necessary on the basis of a degree of similarity of the total sums of the two traffics.

### TECHNICAL FIELD

The present invention relates to a traffic re-application determination device, a traffic re-application determination method, and a traffic re-application determination program.

### BACKGROUND ART

In the network (NW) operation work of communication carriers, when a failure occurs, it is required to quickly identify the failure location and ascertain the extent of the impact. These operations are performed on the basis of NW configuration information (for example, a device name of an NW device, an IP address, a communication port number, and a connection relationship between ports of the NW device).

On the other hand, the current state of the NW configuration changes dynamically due to additions, subtractions, and switching of NW devices, communication ports, NW connections, and the like. Therefore, in order to maintain and operate these, correct management of NW configuration information is important.

In this regard, there is a topology estimation technique that compares time-series data of the amount of transmitted and received traffic acquired from each interface (IF) of the NW device and estimates that the IFs with the highest degree of similarity in the amount of transmitted and received traffic have a connection relationship (see PTL 1).

Specifically, an amount of received traffic IF(t) . in and an amount of transmitted traffic IF(t).out of each IF at time t are acquired, “IFᵢ(t).in-IFⱼ(t).out” and “IFⱼ(t).in-IFᵢ(t).out” are determined for each of the i-th and j-th IFs, respectively, and the IFs with the smallest difference between the two determined values are estimated to have a connection relationship.

However, since the topology estimation technique of PTL 1 compares the difference in the traffic amount of each IF, it is difficult to estimate an accurate connection relationship between IFs where the amount of traffic flowing is small and constant, such as in a standby NW device.

Therefore, there is a method of improving the estimation accuracy of the topology estimation technique of PTL 1 by applying test traffic and giving each IF a unique feature amount due to a temporary increase in traffic amount (see PTL 2). Specifically, test traffic is applied to each IF of each standby NW device while shifting the timing, and a feature amount is assigned.

### CITATION LIST

### Patent Literature

[PTL 1] Japanese Patent No. 5695767

[PTL 2] Japanese Patent Application Publication No. 2020-127160

### SUMMARY OF INVENTION

### Technical Problem

However, in a case where an application time interval of the test traffic is narrow, the feature amount due to the test traffic may occur at the same time in a plurality of IFs, and there is a problem that the connection relationship cannot be estimated correctly.

For example, even in a case where test traffic is applied to each IF of a standby NW device A while shifting the timing, due to a time lag until test traffic packets reach the receiving side, feature amounts whose application times partially or in some cases overlap completely appear in each IF of a standby NW device B. Therefore, it becomes complicated to determine in which IF the timing of the feature amounts overlap and what is the cause.

Although it is sufficient to provide a sufficient application time interval, it is difficult to provide a sufficient application time interval while satisfying the specification constraints and operational constraints of the NW device. Furthermore, it is difficult to detect whether the feature amounts occur at the same time or at different times without closely observing the time-series data.

The present invention has been made in view of the above circumstances, and an object of the present invention is to provide a technique that can automatically determine whether or not re-application of traffic is necessary.

### Solution to Problem

A traffic re-application determination device according to one aspect of the present invention includes: a summation unit that calculates a total sum of at least two traffics among a total sum of applied traffic applied to each IF of a predetermined standby NW device among a plurality of standby NW devices, a total sum of transmitted traffic transmitted from each IF of the predetermined standby NW device, and a total sum of received traffic received at each IF of a standby NW device other than the predetermined standby NW device; and a determination unit that determines whether or not re-application of the applied traffic is necessary on the basis of a degree of similarity of the total sums of the two traffics.

A traffic re-application determination method according to one aspect of the present invention is a traffic re-application determination method performed by a traffic re-application determination device, the traffic re-application determination method including: a step of calculating a total sum of at least two traffics among a total sum of applied traffic applied to each IF of a predetermined standby NW device among a plurality of standby NW devices, a total sum of transmitted traffic transmitted from each IF of the predetermined standby NW device, and a total sum of received traffic received at each IF of a standby NW device other than the predetermined standby NW device; and a step of determining whether or not re-application of the applied traffic is necessary on the basis of a degree of similarity of the total sums of the two traffics.

A traffic re-application determination program according to one aspect of the present invention causes a computer to function as the above-mentioned traffic re-application determination device.

### Advantageous Effects of Invention

According to the present invention, it is possible to provide a technique that can automatically determine whether or not re-application of traffic is necessary.

### BRIEF DESCRIPTION OF DRAWINGS

FIG. 1 is a diagram illustrating an overview of the invention.

FIG. 2 is a diagram illustrating a system configuration according to an embodiment.

FIG. 3 is a diagram showing a processing flow of a traffic re-application determination device.

FIG. 4 is a reference diagram when describing the processing flow.

FIG. 5 is a reference diagram when describing the processing flow.

FIG. 6 is a diagram illustrating a hardware configuration of the traffic re-application determination device.

### DESCRIPTION OF EMBODIMENTS

An embodiment of the present invention will be described below with reference to the drawings. In the drawings, the same portions are denoted by the same reference signs, and the description thereof will be omitted.

### Overview of Invention

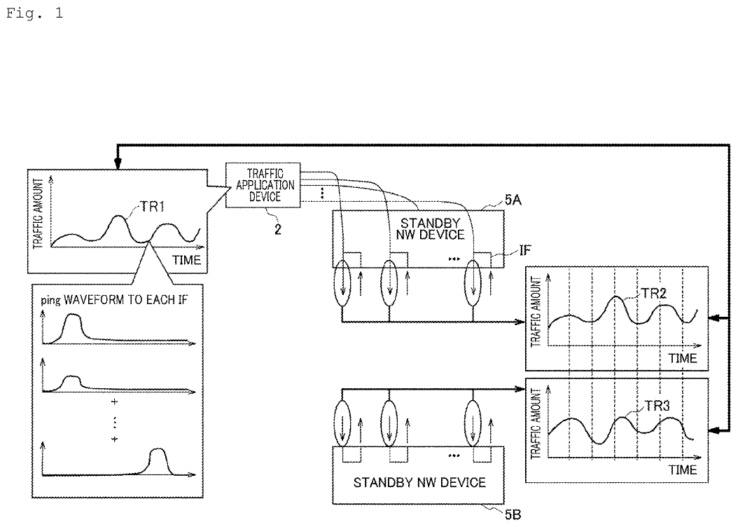

FIG. 1 is a diagram illustrating an overview of the invention. Two standby NW devices 5A and 5B are connected to each other through each IF so that they can communicate with each other or in one direction.

At this time, the total test traffic flow rate applied to the standby NW device 5A by a traffic application device 2 should match the total traffic flow rate corresponding to the feature amounts received by the standby NW device 5B. In a case where they do not match, it is determined that the test traffic application process has not been successful and it is necessary to re-apply the test traffic.

Then, the present invention proposes a method of recommending whether or not re-application of test traffic is necessary on the basis of the deterioration of the degree of matching/similarity between a total applied flow rate TR1 of test traffic applied to each standby NW device 5 by the traffic application device 2 and a total transmitted flow rate TR2 corresponding to the feature amounts transmitted from each standby NW device 5 or a total received flow rate TR3 corresponding to the feature amounts received by each standby NW device 5. Note that only the two of the total transmitted flow rate TR2 and the total received flow rate TR3 may be compared.

### System Configuration and Device Configuration

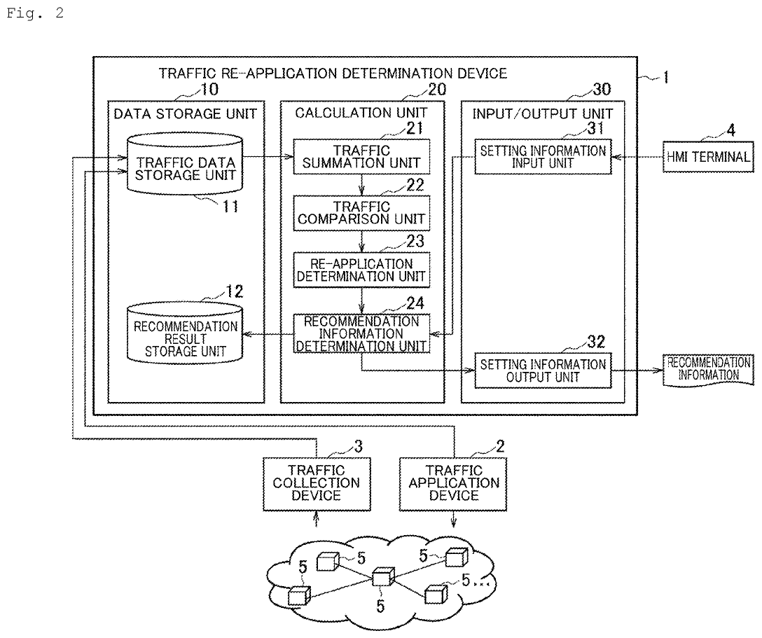

FIG. 2 is a diagram illustrating a system configuration according to the present embodiment. The system according to the present embodiment includes a traffic re-application determination device 1, a traffic application device 2, a traffic collection device 3, an HMI terminal 4, and a plurality of standby NW devices 5. The traffic application device 2 and the traffic collection device 3 may be realized by the same device.

The traffic application device 2 is a device that applies test traffic to each IF of any one or more of the standby NW devices 5 among the plurality of standby NW devices 5. The method of applying test traffic is arbitrary.

The traffic collection device 3 is a device that collects time-series traffic data transmitted from each IF of the standby NW devices 5, and collects time-series traffic data received at each IF of the standby NW device 5, in the plurality of standby NW devices 5 that can communicate with each other or in one direction. The traffic collection device 3 is, for example, a communication carrier's operation system (OpS).

The human machine interface (HMI) terminal 4 is a user terminal for inputting data used in a traffic re-application determination process.

The plurality of standby NW devices 5 are redundant devices that perform processing when a failure occurs in the active NW device. The standby NW device 5 is, for example, a router, a switch, or a transmission device. The plurality of standby NW devices 5 are connected to each other through each IF so that they can communicate with each other or in one direction, but since no actual service traffic flows, the amount of traffic flowing between the standby NW devices 5 is extremely small and almost constant.

The traffic re-application determination device 1 is a device that recommends the necessity of traffic re-application on the basis of a comparison between the total test traffic flow rate applied to the standby NW device 5 and the total traffic flow rate corresponding to the feature amounts transmitted or received by the standby NW device 5.

Specifically, the traffic re-application determination device 1 has a function of comparing the total applied traffic created from traffic application log data of the traffic application device 2 with the total traffic flow rate on the transmitting side or the receiving side of the standby NW device 5, and recommending re-application of traffic as necessary on the basis of the collapse of the degree of matching/similarity of the flow rates.

For example, the traffic re-application determination device 1 includes a data storage unit 10, a calculation unit 20, and an input/output unit 30, as illustrated in FIG. 2.

The data storage unit 10 includes a traffic data storage unit 11 and a recommendation result storage unit 12.

The traffic data storage unit 11 has a function of acquiring and storing traffic application log data of test traffic applied to each IF of the standby NW device 5 by the traffic application device 2 from the traffic application device 2.

Furthermore, the traffic data storage unit 11 has a function of acquiring and storing time-series traffic data transmitted from each IF of the standby NW device 5 from the traffic collection device 3 in response to the application of the test traffic, and acquiring and storing time-series traffic data received at each IF of the standby NW device 5.

The recommendation result storage unit 12 has a function of storing recommendation information indicating the necessity of test traffic re-application determined by the calculation unit 20.

The calculation unit 20 includes a traffic summation unit 21, a traffic comparison unit 22, a re-application determination unit 23, and a recommendation information determination unit 24.

The traffic summation unit 21 has a function of reading traffic application log data from the traffic data storage unit 11 and summing up the traffic application log data applied to each IF of the standby NW device 5.

In addition, the traffic summation unit 21 has a function of reading the time-series traffic data from the traffic data storage unit 11 and summing up the time-series traffic data corresponding to the feature amounts (=test traffic) transmitted from each IF of the standby NW device 5.

In addition, the traffic summation unit 21 has a function of reading the time-series traffic data from the traffic data storage unit 11 and summing up the time-series traffic data corresponding to the feature amounts (=test traffic) received at each IF of the standby NW device 5.

The traffic comparison unit 22 has a function of comparing at least two total values among a first total value of traffic application log data applied to the standby NW device 5, a second total value of the time-series traffic data corresponding to the feature amounts transmitted from the standby NW device 5, and a third total value of the time-series traffic data corresponding to the feature amounts received by the standby NW device 5.

For example, the traffic comparison unit 22 may compare a first total value and a second total value, may compare a first total value and a third total value, may compare a second total value and a third total value, or may compare the first total value to the third total value with each other. The traffic summation unit 21 may calculate only at least two total values to be compared by the traffic comparison unit 22.

Further, the traffic comparison unit 22 may compare data of all time periods including traffic data not related to test traffic, or may extract only the feature amount portion from the traffic application log data or the time-series traffic data and compare the extracted feature amounts.

Note that the method of comparing the total value is arbitrary. For example, the traffic comparison unit 22 performs a comparison using a waveform comparison using dynamic time warping (DTW) or the like or a data analysis library.

The re-application determination unit 23 has a function of determining whether or not re-application of test traffic is necessary on the basis of the comparison result of the two total values performed by the traffic comparison unit 22. The method of determining whether or not re-application is necessary is arbitrary. For example, the re-application determination unit 23 determines that re-application of the test traffic is unnecessary when the degree of matching/similarity between the two total values to be compared is equal to or higher than a threshold value, and determines that re-application of test traffic is necessary when the degree of matching/similarity is not equal to or higher than a threshold value. In addition, the re-application determination unit 23 may make a determination on the basis of the difference between two total values that are compared.

The recommendation information determination unit 24 has a function of determining the determination result of the necessity of test traffic re-application by the re-application determination unit 23 as recommendation information, and storing the recommendation information indicating the necessity of test traffic re-application in the recommendation result storage unit 12.

The input/output unit 30 includes a setting information input unit 31 and a recommendation information output unit 32.

The setting information input unit 31 has a function of receiving setting information necessary for performing the traffic re-application determination process from the HMI terminal 4. For example, the setting information input unit 31 receives a threshold value used in the re-application determination process and display content to be included in the recommendation information.

The recommendation information output unit 32 has a function of outputting the recommendation information determined by the recommendation information determination unit 24.

The function of the traffic re-application determination device 1 has been described above. Since the above function is provided, it is possible to provide a technique that can automatically determine whether or not re-application of traffic is necessary. In addition, the correctness of the assignment of feature amounts based on the applied test traffic can be automatically determined, and the prevention of a decrease in the accuracy of data analysis and the reduction of data observation operations can be expected.

### Operation of Traffic Re-Application Determination Device

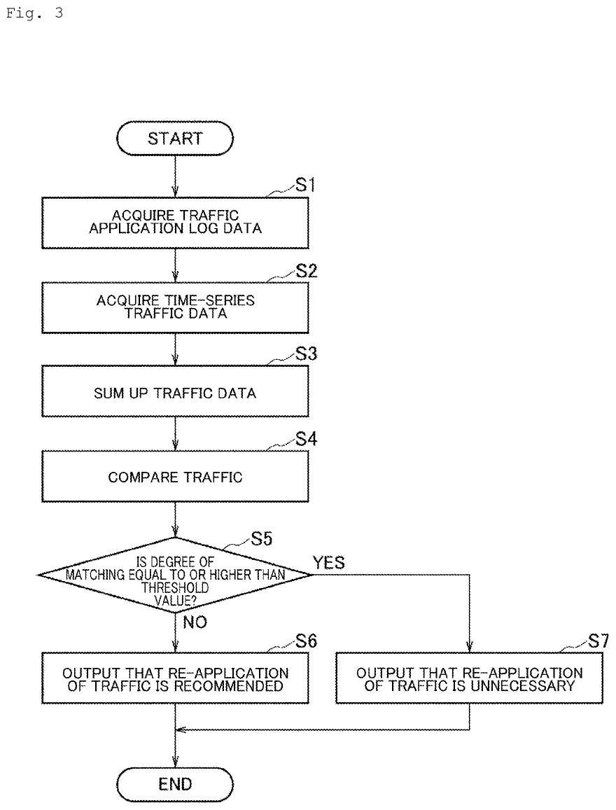

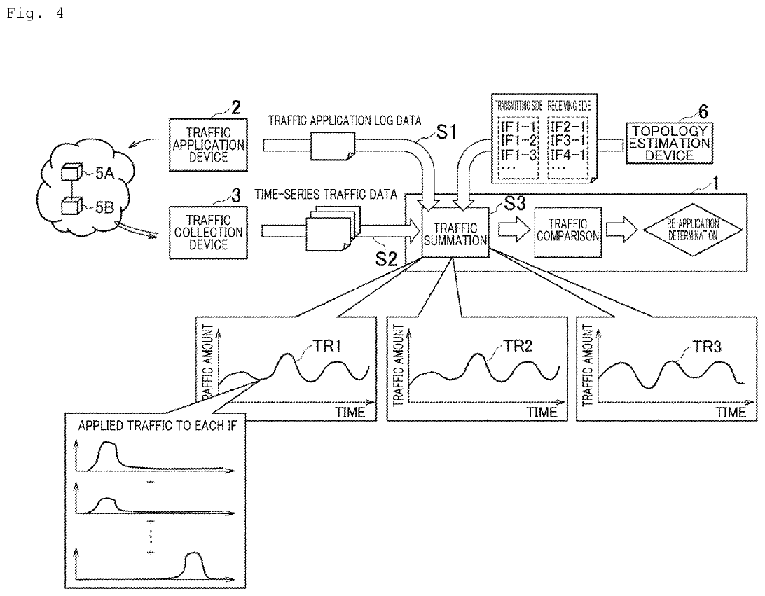

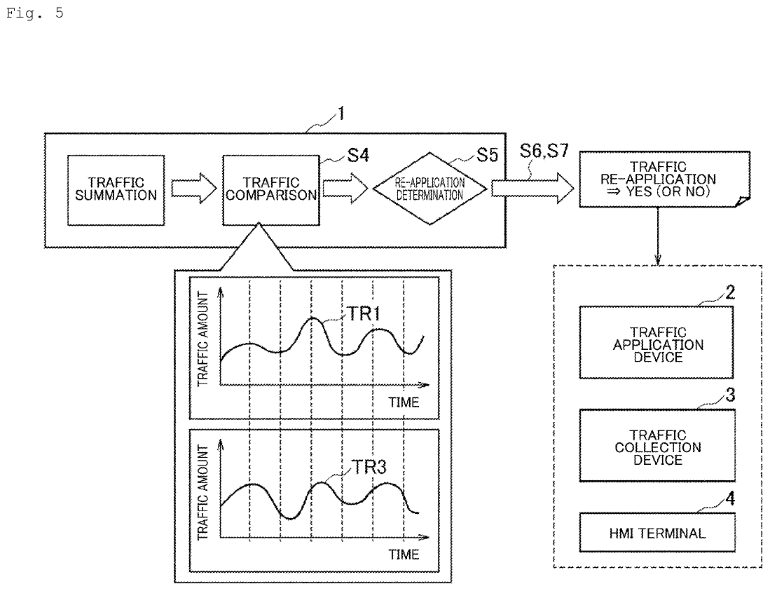

FIG. 3 is a diagram showing a processing flow of the traffic re-application determination device 1. FIGS. 4 and 5 are reference diagrams when describing the processing flow. Here, the two targets of analysis are the standby NW device 5A and the standby NW device 5B.

### Step S1

The traffic data storage unit 11 acquires and stores traffic application log data of test traffic applied to each IF of the standby NW device 5A by the traffic application device 2 from the traffic application device 2.

### Step S2

The traffic data storage unit 11 acquires and stores time-series traffic data transmitted from each IF of the standby NW device 5A from the traffic collection device 3 in response to the application of the test traffic, and acquires and stores time-series traffic data received at each IF of the standby NW device 5B.

Note that time-series traffic data can be acquired, for example, by executing commands such as “$ show pm-interface” or “$ snmpwalk-v 2c-c public,” or by performing packet capture. Moreover, step S2 may be performed before step S1, or may be performed simultaneously with step S1.

### Step S3

The traffic summation unit 21 sums up the traffic application log data of the test traffic applied to each IF of the standby NW device 5A, and obtains the total applied flow rate TR1 after the summation. The traffic summation unit 21 sums up the time-series traffic data corresponding to the feature amounts (=test traffic) transmitted from each IF of the standby NW device 5A, and obtains the total transmitted flow rate TR2 after the summation. The traffic summation unit 21 sums up the time-series traffic data corresponding to the feature amounts (=test traffic) received at each IF of the standby NW device 5B, and obtains the total received flow rate TR3 after the summation.

Note that, in the application method of test traffic, in the case of using a method of applying test traffic by remotely logging into a certain standby NW device and applying test traffic to the opposite standby NW device, the transmitting and receiving sides are identified from the remote login history. In the case of another method, IF data is divided into two equal parts using a first column (transmitting side) and a second column (receiving side) of an IF list output by a topology estimation device 6 (see PTL 1), and the transmitting and receiving sides are identified from the IF data after the division into the two equal parts.

### Step S4

The traffic comparison unit 22 compares the total applied flow rate TR1, which is an ideal value, with the total received flow rate TR3 actually received by the standby NW device 5B. At this time, data of all time periods including traffic data not related to test traffic may be compared, only the feature amount portion may be extracted from the traffic application log data or the time-series traffic data and compared. The reason why data for all time periods including traffic data not related to test traffic may be compared is that the amount of traffic flowing between the standby NW devices 5 is extremely small.

### Step S5

In a case where the total applied flow rate TR1 and the total received flow rate TR3 are not similar, for example, in a case where their degree of matching is not equal to or higher than a threshold value, the re-application determination unit 23 determines that the timing of assigning the feature amount using the test traffic is not appropriate, and determines that re-application of the test traffic is recommended as a determination result.

On the other hand, in a case where the total applied flow rate TR1 and the total received flow rate TR3 are similar, for example, in a case where their degree of matching is equal to or higher than a threshold value, the re-application determination unit 23 determines that the timing of assigning the feature amount using the test traffic is appropriate, and determines that re-application of the test traffic is unnecessary as a determination result.

### Step S6

In a case where the total applied flow rate TR1 and the total received flow rate TR3 are not similar, the recommendation information determination unit 24 determines the determination result that re-application of the test traffic is recommended as recommendation information. Thereafter, the recommendation information output unit 32 outputs the recommendation information to the traffic application device 2, the traffic collection device 3, and the HMI terminal 4.

### Step S7

In a case where the total applied flow rate TR1 and the total received flow rate TR3 are similar, the recommendation information determination unit 24 determines the determination result that re-application of the test traffic is unnecessary as recommendation information. Thereafter, the recommendation information output unit 32 outputs the recommendation information to the traffic application device 2, the traffic collection device 3, and the HMI terminal 4.

In addition, in step S4, the traffic comparison unit 22 may compare, for example, the total transmitted flow rate TR2 actually transmitted by the standby NW device 5A and the total received flow rate TR3 actually received by the standby NW device 5B. In this case, the “total applied flow rate TR1” in steps S5 to S7 is replaced with “total transmitted flow rate TR2.”

Alternatively, in steps S4 to S7, only time portions with a low degree of traffic similarity may be extracted, only those IFs that are considered to have degraded accuracy may be output as determination results as re-applying targets by comparing the extracted time portions with the traffic application log.

### Effects

As described above, the traffic re-application determination device 1 according to the present invention includes: the traffic summation unit 21 that calculates a total sum of at least two traffics among a total sum of applied traffic applied to each IF of a predetermined standby NW device 5 among a plurality of standby NW devices 5, a total sum of transmitted traffic transmitted from each IF of the predetermined standby NW device 5, and a total sum of received traffic received at each IF of a standby NW device 5 other than the predetermined standby NW device 5; and the re-application determination unit 23 that determines whether or not re-application of the applied traffic is necessary on the basis of a degree of similarity of the total sums of the two traffics.

Since these functional units are provided, the present invention can provide a technique that can automatically determine whether or not re-application of traffic is necessary. In addition, the correctness of the assignment of feature amounts based on the applied test traffic can be automatically determined, and the prevention of a decrease in the accuracy of data analysis and the reduction of data observation operations can be expected.

### Others

The present invention is not limited to the embodiment described above. The present invention can be modified in a number of ways within the scope of the gist of the present invention.

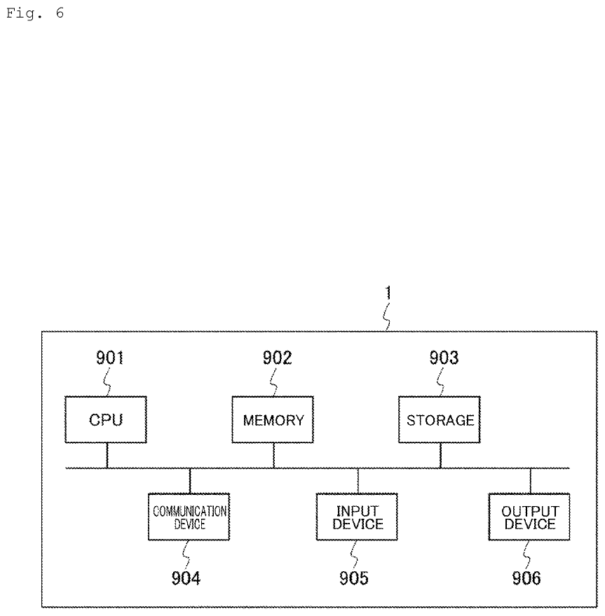

The traffic re-application determination device 1 of the present embodiment described above can be realized by using a general-purpose computer system including a CPU 901, a memory 902, a storage 903, a communication device 904, an input device 905, and an output device 906, for example, as illustrated in FIG. 6. The memory 902 and the storage 903 are storage devices. In the computer system, each function of the traffic re-application determination device 1 is implemented by the CPU 901 executing a predetermined program loaded onto the memory 902.

The traffic re-application determination device 1 may be mounted as one computer. The traffic re-application determination device 1 may be mounted as a plurality of computers. The traffic re-application determination device 1 may be a virtual machine mounted in a computer. A program for the traffic re-application determination device 1 can be stored in a computer-readable recording medium such as an HDD, an SSD, a USB memory, a CD, and a DVD. A program for the traffic re-application determination device 1 can also be distributed via a communication network.

### REFERENCE SIGNS LIST

1 Traffic re-application determination device
10 Data storage unit
11 Traffic data storage unit
12 Recommendation result storage unit
20 Calculation unit
21 Traffic summation unit
22 Traffic comparison unit
23 Re-application determination unit
24 Recommendation information determination unit
30 Input/output unit
31 Setting information input unit
32 Recommendation information output unit
2 Traffic application device
3 Traffic collection device
4 HMI terminal
5 Standby NW device
6 Topology estimation device
901 CPU
902 Memory
903 Storage
904 Communication device
905 Input device
906 Output device

1. A traffic re-application determination device comprising:
a summation unit, comprising one or more processors, configured to calculate a total sum of at least two traffics among a total sum of applied traffic applied to each IF of a predetermined standby network (NW) device among a plurality of standby NW devices, a total sum of transmitted traffic transmitted from each IF of the predetermined standby NW device, and a total sum of received traffic received at each IF of a standby NW device other than the predetermined standby NW device; and
a determination unit, comprising one or more processors, configured to determine whether or not re-application of the applied traffic is necessary on the basis of a degree of similarity of the total sums of the two traffics.

2. The traffic re-application determination device according to claim 1, wherein the summation unit is configured to determine whether or not re-application of the applied traffic is necessary on the basis of a degree of similarity between the total sum of the applied traffic and the total sum of the received traffic.

3. The traffic re-application determination device according to claim 1, wherein the summation unit is configured to determine whether or not re-application of the applied traffic is necessary on the basis of a degree of similarity between the total sum of the transmitted traffic and the total sum of the received traffic.

4. A traffic re-application determination method performed by a traffic re-application determination device, the traffic re-application determination method comprising:
calculating a total sum of at least two traffics among a total sum of applied traffic applied to each IF of a predetermined standby network (NW) device among a plurality of standby NW devices, a total sum of transmitted traffic transmitted from each IF of the predetermined standby NW device, and a total sum of received traffic received at each IF of a standby NW device other than the predetermined standby NW device; and
determining whether or not re-application of the applied traffic is necessary on the basis of a degree of similarity of the total sums of the two traffics.

5. A non-transitory computer readable medium storing a program, wherein execution of the program causes a computer to function as the traffic re-application determination device according to claim 1.
